(19) United States
(12) Patent Application Publication
(10) Pub. No.: US 2020/0228846 A1
(43) Pub. Date: Jul. 16, 2020

(54) Apparatus and Method for Hierarchical Wireless Video and Graphics Transmission Based on Video Preprocessing

(71) Applicant: SZ DJI TECHNOLOGY CO., LTD., Shenzhen (CN)

(72) Inventor: Lei Zhu, Shenzhen (CN)

(73) Assignee: SZ DJI TECHNOLOGY CO., LTD., Shenzhen (CN)

(21) Appl. No.: 16/832,148

(22) Filed: Mar. 27, 2020

Related U.S. Application Data
(63) Continuation of application No. PCT/CN2018/109018, filed on Sep. 30, 2018.

(51) Int. Cl. H04N 19/86

(52) U.S. Cl. CPC H04N 19/86

(57) ABSTRACT

Methods and systems are provided for preprocessing content, controlling one or more state parameters associated with a moveable object, and controlling the preprocessing operations. For example, to an image processing method includes receiving, by a processor, one or more images from an imaging device carried on a movable object and adjusting one or more imaging parameters of at least one of the one or more images to obtain an adjusted image. The method further includes encoding the adjusted image to generate encoded image data transmitting the encoded image data from the movable object to a remote terminal.

### BACKGROUND

### Field

This disclosure generally relates to preprocessing content such as images, video, or graphics and bit rate control for wireless transmission of the content.

### Related Art

In conventional video transmission systems, a video is first encoded using video coding (e.g., compression) techniques. The encoded video is then transmitted to a receiver device over a communication channel. The coding techniques and parameters used for the video coding can affect, for example, a bit rate associated with the encoded video, a peak signal-to-noise ratio (PSNR) of the encoded video, and/or an occupied space in a buffer, which can affect the quality of the encoded video upon playback. Additionally, a transmitter device that transmits the encoded video, the receiver device that receives the encoded data, or the communication channel on which the encoded video is transmitted can have constraints that may affect the quality of the encoded video upon playback.

### SUMMARY

The described embodiments relate to methods and systems for preprocessing content before encoding the content. For example, a system can include preprocessing circuitry for processing input data and controlling one or more parameters associated with the preprocessing circuitry, an encoder for encoding the processed data to generate encoded data, a rate controller for controlling a bit rate associated with the encoded data, and a transmitter for transmitting the encoded data.

Some embodiments relate to an image processing method including receiving, by a processor, one or more images from an imaging device carried on a movable object and adjusting one or more imaging parameters of at least one of the one or more images to obtain an adjusted image. The method further includes encoding the adjusted image to generate encoded image data for transmitting the encoded image data from the movable object to a remote terminal.

Some embodiments relate to an image processing method including receiving, by a processor, one or more images from an imaging device of a movable object and determining, based on one or more state parameters associated with the movable object, whether to adjust one or more imaging parameters of at least one of the one or more images to obtain an adjusted image before encoding the one or more images.

Some embodiments relate to an image processing method including receiving, by a processor, one or more images from an imaging device of a movable object and determining whether one or more state parameters associated with the moveable object are within a preset range. In response to the one or more state parameters not being within a preset range, the method includes adjusting one or more imaging parameters of at least one of the one or more images to obtain an adjusted image and encoding the adjusted image to generate encoded image data. In response to the one or more state parameters being within the preset range, the method includes encoding the at least one of the one or more images to generate an encoded image data. The method further includes transmitting the encoded image data from the movable object to a remote terminal.

Some embodiments relate to an imaging system. The imaging system includes an imaging device carried on a movable object and configured to capture one or more images and one or more processors. The one or more processors, upon executing instructions, individually or collectively, adjust one or more imaging parameters of at least one of the one or more images to obtain an adjusted image and encode the adjusted image to generate encoded image data. The one or more processors further transmit, using a transceiver, the encoded image data from the movable object to a remote terminal.

Some embodiments relate to an imaging system. The imaging system includes an imaging device carried on a movable object and configured to capture one or more images and one or more processors. The one or more processors, upon executing instructions, individually or collectively, receive the one or more images from the imaging device and determine, based on one or more state parameters associated with the movable object, whether to adjust one or more imaging parameters of at least one of the one or more images to obtain an adjusted image before encoding the one or more images.

Some embodiments relate to an imaging system. The imaging system includes an imaging device carried on a movable object and configured to capture one or more images and one or more processors. The one or more processors, upon executing instructions, individually or collectively, determine whether one or more state parameters associated with the moveable object are within a preset range. In response to the one or more state parameters not being within a preset range, the one or more processors adjust one or more imaging parameters of at least one of the one or more images to obtain an adjusted image and encode the adjusted image to generate encoded image data. In response to the one or more state parameters being within the preset range, the one or more processors encode the at least one of the one or more images to generate an encoded image data. The one or more processors further transmit, using a transceiver, the encoded image data from the movable object to a remote terminal.

Some embodiments relate to a non-transitory computer program product including machine readable instructions. The machine readable instructions cause a programmable processing device to perform operations including receiving one or more images from an imaging device carried on a movable object and adjusting one or more imaging parameters of at least one of the one or more images to obtain an adjusted image. The operations further include encoding the adjusted image to generate encoded image data transmitting the encoded image data from the movable object to a remote terminal.

Some embodiments relate to a non-transitory computer program product including machine readable instructions. The machine readable instructions cause a programmable processing device to perform operations including receiving one or more images from an imaging device of a movable object and determining, based on one or more state parameters associated with the movable object, whether to adjust one or more imaging parameters of at least one of the one or more images to obtain an adjusted image before encoding the one or more images.

Some embodiments relate to a non-transitory computer program product including machine readable instructions. The machine readable instructions cause a programmable processing device to perform operations including receiving one or more images from an imaging device of a movable object and determining whether one or more state parameters associated with the moveable object are within a preset range. In response to the one or more state parameters not being within a preset range, the operations further include adjusting one or more imaging parameters of at least one of the one or more images to obtain an adjusted image and encoding the adjusted image to generate encoded image data. In response to the one or more state parameters being within the preset range, the operations further include encoding the at least one of the one or more images to generate an encoded image data. The operations further include transmitting the encoded image data from the movable object to a remote terminal.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 is a block diagram depicting an example of a system for performing the preprocessing and parameter control, according to some embodiments.

FIG. 2A is a block diagram depicting an example of a system for performing the preprocessing and parameter control, according to some embodiments.

FIG. 2B is a block diagram depicting an example of preprocessing circuitry, according to some embodiments.

FIG. 3A is a flowchart depicting an example method for preprocessing, according to some embodiments.

FIGS. 3B-3D are flowcharts depicting example methods for implementing step 303 of method 300 of FIG. 3A, according to some embodiments.

FIGS. 4A-4D are flowcharts depicting an example method for preprocessing and parameter control, according to some embodiments.

FIG. 5 is an example computer system useful for implementing some embodiments or portion(s) thereof.

The presented disclosure is described with reference to the accompanying drawings.

In the drawings, generally, like reference numbers indicate identical or functionally similar elements. Additionally, generally, the left-most digit(s) of a reference number identifies the drawing in which the reference number first appears.

### DETAILED DESCRIPTION

According to some embodiments, content, including but not limited to, video data, image data, graphics data, etc., are encoded (e.g., compressed) into encoded data before the encoded data is transmitted or stored. The number of bits used to encode a unit of data (e.g., a frame of a video) per unit of time (e.g., a second) is referred to as the bit rate, according to some examples. Due to some constraints associated with, for example, a transmitter that transmits the encoded data, a receiver that receives the encoded data, a storage medium used to store the encoded data, or a communication channel on which the encoded data is transmitted, bit rate control techniques can be used to control one or more parameters associated with the coding techniques used to generate the encoded data. For example, due to transmission bandwidth constraints of the communication channel, bit rate control techniques can be used to control quantization parameters of the coding techniques used to generate the encoded data. These bit rate control techniques can be used to achieve a match between the bit rate associated with the encoded data and the bandwidth of the communication channel, for example.

However, the parameters (e.g., the quantization parameter) of the coding techniques can have upper or lower value limits such that the bit rate control techniques cannot further change these parameters in order to control the bit rate. For example, the quantization parameter has a maximum value limit defined by the coding technique. In some circumstances, a target bit rate cannot be achieved even though the quantization parameter reaches this maximum value. As the target bit rate cannot be achieved, video lags will be experienced at the receiver device's side, according to some examples.

Coding techniques used to encode the content into the encoded data can affect the quality of the encoded data upon playback at the receiver device. For example, a peak signal-to-noise ratio (PSNR) value (e.g., determined by decoding the encoded data and comparing it with the content) and/or storage space of one or more buffers used to store the encoded data can affect the quality of the encoded data upon playback at the receiver device. Additionally, the bit rate control techniques used to control the one or more parameters of the coding techniques can further affect the quality of the encoded data. In some examples, video quality degradation and loss, especially subjective video quality, are determined by the coding techniques and algorithms being used rather than under user control.

The embodiments of this disclosure are directed to control one or more parameters associated with the coding techniques (such as, but not limited to, bit rate, PSNR, buffer size, etc.) by actively preprocessing the content and by actively controlling one or more parameters of the preprocessing, for example, before applying the coding techniques. Accordingly, the quality of the encoded data can be actively controlled. Further, even if the upper or lower value limits of the parameters of the coding techniques are reached, a target bit rate can still be achieved by preprocessing the content before encoding, according to some embodiments. This can provide, for example, smooth transmission of the encoded data. The embodiments of this disclosure can achieve target bit rates, target PSNRs, target buffer sizes, and prevent breaks in the transmission of the encoded data for example over long distances.

The preprocessing and parameter control of the embodiments of this disclosure can increase the quality of the coding techniques and can keep the parameters (e.g., the quantization parameter) of the coding techniques within high quality range. For example, if the parameters of the coding techniques fall outside of the high quality range during the bit rate control, the preprocessing techniques of this disclosure are used to bring back and keep the parameters of the coding techniques within the high quality range. The preprocessing and parameter control of the embodiments of this disclosure can result in higher quality encoded data, in better transmission quality (e.g., less lag time) for transmitting the encoded data, in achieving target bit rates, etc.

Additionally, by using the preprocessing and parameter control of the embodiments of this disclosure, the quality of the encoded data (for example, upon playback) is in accordance with a predefined quality classification. In other words, important information (e.g., edge information, high frequency information, etc.) of the content can be kept by using the embodiments of this disclosure, and the image quality is not controlled only by the bit rate control technique.

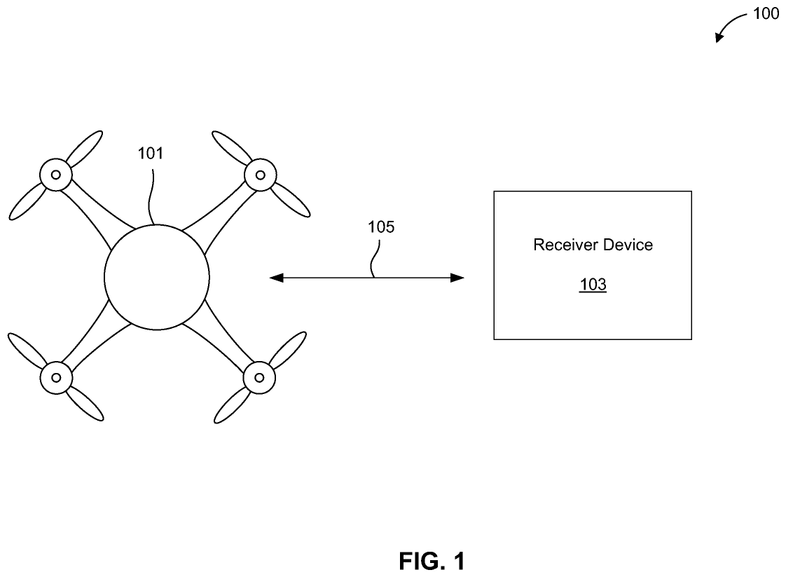

FIG. 1 is a block diagram depicting an example of a system 100 for performing the preprocessing and parameter control, according to some embodiments. As illustrated in FIG. 1, system 100 can include movable object (such as, but not limited to, an unmanned aerial vehicle (UAV)) 101 and remote terminal (e.g., a receiver device) 103 communicating with each other over communication channel 105.

According to some embodiments, the UAV 101 can be configured to collect data, process the collected data, and transmit the processed data over the communication channel 105 to the receiver device 103. For example, the UAV 101 can be configured to collect data that can include, but is not limited to, video data, image data, graphic data, audio data, text data, or the like. For example, the UAV 101 collects data that can be generated by one or more sensors, such as but not limited to, vision sensors (e.g., cameras, infrared sensors), microphones, proximity sensors (e.g., ultrasound, lidar), position sensors, temperature sensors, touch sensors, etc. In some examples, the data collected by the UAV 101 can include data from a user such as biometric information including, but not limited to, facial features, fingerprint scan, retina scan, voice recording, DNA samples, etc.

According to some embodiments, receiver device 103 can include, but is not limited to, a remote control, a laptop computer, a desktop computer, a tablet computer, a television receiver, a display device, a mobile phone, an automobile-based device, an aircraft-based device, etc. The receiver device 103 is configured to receive the transmitted data from the UAV 101 over the communication channel 105. The receiver device 103 is further configured to process the received data and, for example, display the data on a display device. In some embodiments, the receiver device 103 is also configured to transmit information about the received data or the communication channel 105 back to the UAV 101 over the communication channel 105.

According to some examples, the communication channel 105 can include or be associated with wired or wireless networks such as the Internet, local area networks (LAN), wide area networks (WAN), storage area networks (SAN), point-to-point networks (P2P), WiFi networks, Bluetooth, Bluetooth Low Energy, radio networks, Long-Term Evolution (LTE), 3G, 4G, 5G networks, or other networks.

According to some embodiments, and as discussed in more detail below, the UAV 101 is configured to encode the collected data to generate encoded data before transmitting the encoded data to the receiver device 103. The UAV 101 is further configured to control one or more state parameters associated with the UAV 101. The one or more state parameters associated with the UAV 101 can include, but are not limited to, one or more parameters of an encoder of the UAV 101 (e.g., bit rate, quantization parameter, PSNR, storage space of a buffer, etc.) In some embodiments, the UAV 101 is configured to preprocess the collected data before encoding the collected data. The UAV 101 is configured to preprocess the collected data if one or more state parameters associated with the UAV 101 are not within a preset range. The UAV 101 is also configured to adjust one or more parameters of the preprocessing if one or more state parameters associated with the UAV 101 are not within a preset range. Accordingly, the quality of the encoded data can be actively controlled. This can provide, for example, smooth transmission of the encoded data with less delay in the transmission.

By applying the preprocessing and parameter control of the embodiments of this disclosure, the UAV 101 can increase the quality of the coding techniques it uses and can keep parameters of its coding techniques within high quality range. If the parameters of its coding techniques fall outside of the high quality range, the UAV 100 is configured to use the preprocessing techniques of this disclosure to bring back and keep the parameters of the coding techniques within the high quality range. Accordingly, the UAV 101 can be configured to transmit higher quality encoded data, in better transmission quality (e.g., less lag time) for transmitting the encoded data, achieve target bit rates, etc., by using the preprocessing and parameter control of the embodiments of this disclosure.

It is noted that although one UAV and one receiver device are depicted in FIG. 1, the embodiments of this disclosure can include one or more UAVs communicating with one or more receiver devices over one or more communication channels. Also, system 100 of FIG. 1 is provided as an exemplary environment. The embodiments of this disclosure are not limited to this system and the UAV 101 can include any movable object and receiver device 103 can include any remote terminal. These embodiments of this disclosure can be applied to systems including other devices, such as but not limited to, Unmanned Aerial System (UAS), bicycle, automobile, truck, ship, boat, train, helicopter, aircraft, robot, or the like.

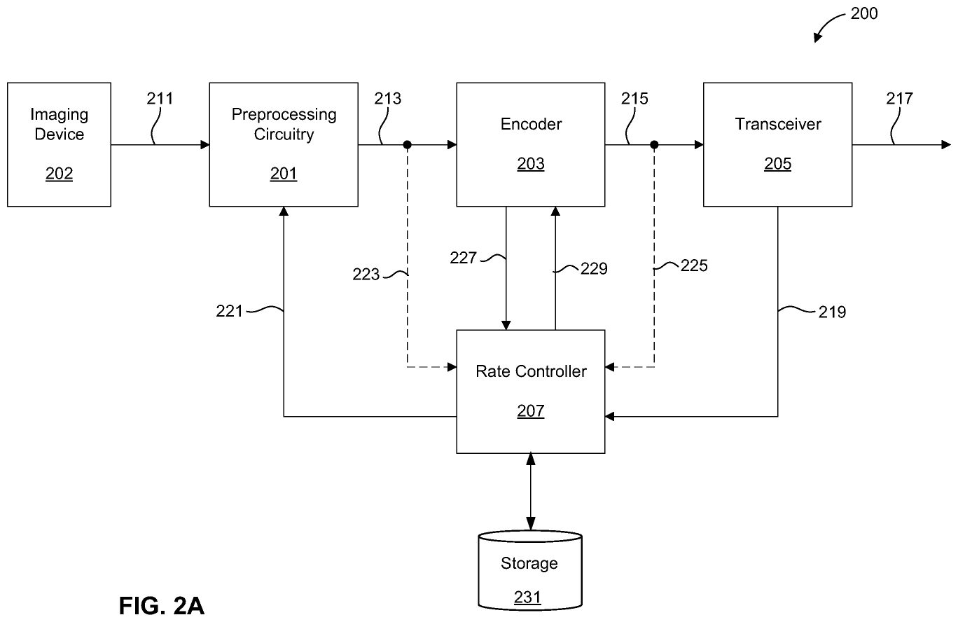

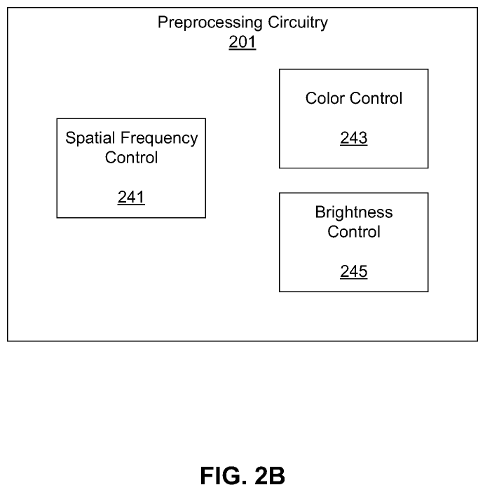

FIG. 2A is a block diagram depicting an example of a system 200 for performing the preprocessing and parameter control, according to some embodiments. For example, system 200 can be part of or be associated with the UAV 101 of FIG. 100.

As illustrated in FIG. 2A, system 200 can include preprocessing circuitry 201, imaging device 202, encoder 203, transceiver 205, and storage 231. As discussed in more detail below, system 200 is configured to, for example, control the bit rate associated with encoded data while keeping coding parameters of the encoder 203 within high quality range by using, for example, the preprocessing circuitry 201. According to some examples, the high quality range of the coding parameters of the encoder 203 can include a predetermined range where the encoded data encoded by the encoder 203 has a predefined quality. According to some embodiments, the rate controller 207 is configured to control the bit rate associated with the encoded data by adjusting the coding parameters of the encoder 203. If the coding parameters of the encoder 203 fall outside of the high quality range during the bit rate control, the rate controller 207 and the preprocessing circuitry 201 are configured to bring back and keep the coding parameters within the high quality range.

The imaging device 202 can include one or more sensors, such as but not limited to, vision sensors (e.g., cameras, infrared sensors), microphones, proximity sensors (e.g., ultrasound, lidar), position sensors, temperature sensors, touch sensors, etc., according to some embodiments. The data captured by the imaging device 202 is input to the preprocessing circuitry 201. Although this disclosure discusses image and image data as data captured by the imaging device 202 and as input data 211, the embodiments of this disclosure are not limited to image data. Input data 211 can include, but is not limited to, video data, image data, graphic data, audio data, text data, or any other data to be encoded. In some examples, the input data 201 can be data from a user such as biometric information including, but not limited to, facial features, fingerprint scan, retina scan, voice recording, DNA samples, etc.

The preprocessing circuitry 201 receives or retrieves input data 211. As discussed in more detail below, the preprocessing circuitry 201 is configured to process the input data 211 before the input data 211 is encoded by the encoder 203. The encoder input data 213, which is the output of the preprocessing circuitry 201, is input to the encoder 203. The encoder 203 encodes the encoder input data 213 to generate encoded data 215. The rate controller 207 is configured to control the bit rate associated with the encoded data 215 while controlling the preprocessing circuitry 201 such that coding parameters of the encoder 203 are within acceptable range(s). In some examples, the encoded data 215 is transmitted 217 using, for example, the transceiver 205 over a communication channel to a remote terminal. Additionally or alternatively, the encoded data 215 is stored in a storage device.

According to some examples, when the preprocessing circuitry 201 receives the input data 211 (e.g., one or more images) from the imaging device 202, the preprocessing circuitry 201 (alone or in combination with rate controller 207) is configured to determine whether to preprocess the input data 211. The preprocessing the input data 211 can include adjusting one or more imaging parameters of the input data 211. For example, the preprocessing the input data 211 can include reducing one or more imaging parameters of the input data 211. According to some examples, the one or more imaging parameters can include, but are not limited to, a spatial frequency of an image, a dimensionality of a color space of an image, and/or a dimensionality of a brightness space of an image. The preprocessing circuitry 201 is configured to adjust one of the imaging parameters, according to some examples. Additionally or alternatively, the processing circuitry 201 can adjust two or more of the imaging parameters. For example, the processing circuitry 201 can adjust two or more of the imaging parameters based on a preset priority. In some examples, adjusting spatial frequency can have higher priority compared to adjusting the dimensionality of the color space and/or adjusting the dimensionality of the brightness space.

The preprocessing circuitry 201 is configured to determine whether to preprocess the input data 211 based on one or more state parameters associated with system 200. As discussed in more detail below, the preprocessing circuitry 201 (alone or in combination with rate controller 207) is configured to determine one or more state parameters associated with system 200, compare the one or more state parameters with one or more preset values (e.g., one or more preset ranges), and determine whether to preprocess the input data 211 based on the comparison.

According to some embodiments, the one or more state parameters associated with system 200 can include a quantization parameter of the encoder 203. This quantization parameter can include a quantization parameter used for encoding prior input data (e.g., one or more images received prior to the input data 211.) Additionally or alternatively, this quantization parameter can include an adjusted quantization parameter obtained by adjusting a quantization parameter used for encoding one or more images received prior to the input data 211, where the adjustment can be made based, at least, on bandwidth of a communication channel (e.g., communication channel 105 of FIG. 1). For example, the preprocessing circuitry 201 can determine to preprocess the input data 211 if the quantization parameter of the encoder 203 used for encoding prior input data is equal to or greater than a first quantization parameter threshold.

Additionally or alternatively, the one or more state parameters associated with system 200 can include PSNR value(s) of prior input data (e.g., one or more images received prior to the input data 211.) For example, the preprocessing circuitry 201 can determine to preprocess the input data 211 if the PSNR value(s) of prior input data is equal to or less than a PSNR threshold. According to some embodiments, the PSNR value associated with an image received prior to the input data 211 is obtained by encoding and decoding that image. For example, the image is first encoded using, for example, the encoder 203, then the encoded image is decoded (using for example a decoder (not shown)), and the decoded version and the original version of that image are compared to determine the PSNR value of that image.

In addition to or alternative to the quantization parameter and/or the PSNR value, the one or more state parameters associated with system 200 can include an occupied storage space(s) in one or more buffers used to store encoded data associated with prior input data (e.g., one or more images received prior to the input data 211.) For example, the preprocessing circuitry 201 can determine to preprocess the input data 211 if the occupied storage space(s) in one or more buffers used to store encoded data associated with prior input data is equal to or greater than a threshold.

It is noted that although quantization parameter, PSNR value, and/or storage space in a buffer are discussed as examples for one or more state parameters associated with system 200, the embodiments of this disclosure are not limited to these examples and other parameters of system 200 can be used by the preprocessing circuitry 201 to determine whether to preprocess the input data 211.

Some examples of using the quantization parameter of the encoder 203 as one state parameter to determine whether to preprocess the input data 211 is now discussed in more detail. Encoding the encoder input data 213 (the input to encoder 203) can include data compression, encryption, error encoding, format conversion, and the like. For example, the encoder input data 213 can be compressed to reduce a number of bits that are transmitted over a communication channel. In another example, the encoder input data 213 can be encrypted to protect the encoder input data 213 during transmission and/or storage. Different types of encoding techniques can be used to encode the encoder input data 213. The type of the encoding technique can be determined based on, for example, the type of the encoder input data 213, the requirements of the device encoding the encoder input data 213, the type of storage and/or the type of the communication channel used for storing and/or transmitting the encoded data, the security requirements, etc. The encoding techniques can include, but are not limited to, video compression, audio compression, lossy compression, lossless compression, Huffman coding, Lempel-Ziv-Welch (LZW) compression, etc.

According to some examples, the encoding can include a transform step, a quantization step, and an entropy encoding step. For example, during the transform step, the raw encoder input data 213 is transformed from a first domain into a different domain (for example, spatial frequency domain) suitable for the data content of the encoder input data 213 (for example, video data). Any suitable transform coding technique can be used including, but not limited to, Fourier-type transforms such as discrete cosine transform (DCT) or modified DCT. According to some examples using DCT, a DCT matrix is determined based on, for example, the size of the data unit. The data unit can include a block of 4×4 or 8×8 pixels, a macroblock of 16×16 pixels, any suitable set of data. The DCT matrix is then applied to the data unit using matrix multiplication to create a transformed matrix comprising transform coefficients.

In the quantization step, the coefficients in the transformed matrix can be quantized by, for example, dividing each transform coefficient by a corresponding element in a quantization matrix, and then rounding to the nearest integer value. The quantization matrix can be derived using a quantization parameter (also referred to as a quantization index). According to some examples, the quantization parameter can be the value for each element of the quantization matrix. As another example, some or all of the elements in the quantization matrix can be multiplied (e.g., scaled) by the quantization parameter and the scaled quantization matrix can be used to quantize the transformed matrix. According to some embodiments, the quantization parameter can be a value (e.g., an integer) within a certain range (e.g., between and including a lower threshold of Q^{L} and an upper threshold of Q^{H}.) In a non-limiting example, the quantization parameter can be between and including 0 and 50. According to some examples, the higher the value of the quantization parameter, the larger the quantization step size is and the larger are the elements in the quantization matrix. This can cause more transform coefficients to be quantized to zero or near-zero, and less bits are used to encode the quantized coefficient. The more zero or near-zero coefficients there are, the less bits are used to encode the coefficients, resulting in lower bit size (and hence lower bit rate) for the data unit represented by the coefficients. The opposite is also true, that a lower value of the quantization parameter corresponds to smaller quantization step size, a greater number of bits used to encode the quantize coefficients, a higher bit size (and hence higher bit rate) for the data unit encoded using the quantization parameter.

Some embodiments of this disclosure are directed to methods and system for preprocessing the encoder input data 213 and for controlling the bit rate of the encoded data 215 such that parameters such as for example the quantization parameter are kept within a high quality range.

In the entropy encoding step, the quantize coefficients in the quantized matrix are scanned in a predetermined order and encoded using any suitable coding technique, according to some embodiments. In some examples, since most of the non-zero DCT coefficients are likely concentrated in an upper left-hand corner of the matrix, a zigzag scanning pattern from the upper left to the lower right is typical. Alternatively, other scanning orders such as a raster scan can be used. The scanning order can be used to maximize the probability of achieving long runs of consecutive zero coefficients. The scanned coefficients can then be encoded using run-length encoding, variable-length encoding, or any other entropy encoding technique, to generate the encoded data 215.

According to some examples, the rate controller 207 is configured to control the bit rate of the encoded data 215. For example, the rate controller 207 is configured to control the bit rate to be within a range (e.g., less than a maximum bit rate and greater than a minimum bit rate.) Additionally or alternatively, the rate controller 207 can control the bit rate to be close to (or substantially close to) a target bit rate (e.g., an average target bit rate.) In some examples, the rate controller 207 is configured to control the bit rate to vary depending on the encoder input data 213.

In order to control the bit rate of the encoded data 215, the rate controller 207 is configured to determine or adjust (e.g., update) the coding parameters associated with the encoder 203, according to some examples. In some embodiments, the coding parameters can include one or more quantization parameters for controlling the quantization step of the encoding process of the encoder 203, and/or therefore, the bit rate of the resulting encoded data 215. The quantization parameters can include a quantization step size, a value related to the quantization step size such as quantization parameter (QP) used in H.264 encoder or similar encoders, a quantization matrix or one or more parameters related to the quantization matrix, or other related parameters, according to some embodiments.

It is noted that although the coding parameters are discussed is some embodiments as the quantization parameters, the embodiments of this disclosure are not limited to these examples and other coding parameters can be used by the rate controller 207 to control the bit rate. For example, the coding parameters can include parameters for controlling other aspects of the encoding process such, but not limited to, a prediction step, the transform step, or the entropy encoding step. For example, the coding parameters can include a cutoff index used for removing certain high frequency coefficients before the coefficients are entropy encoded. As another examples, the coding parameters can include bit allocation information (e.g., maximum, minimum, or target bits allocated for encoding a data unit), a frame rate, a size of a data unit to be transformed and quantized, motion detection thresholds used to determine whether to code or skip coding a data unit (e.g., macroblock), Lagrange multiplier used in rate distortion optimization, algorithms and parameters used for the prediction, transform or entropy encoding steps, or other similar parameters.

To adjust the coding parameters (e.g., the quantization parameters), the rate controller 207 receives or retrieves transmission information 219, input information 223, output information 225, or encoder information 227, according to some embodiments. Based on the received or retrieved information, the rate controller 207 is configured to adjust the coding parameters associated with the encoder 203. The rate controller 207 transmits the adjusted coding parameters 229 to the encoder 203. In some examples, the encoder 203 is configured to retrieve the adjusted coding parameters 229 from the rate controller 207. Additionally or alternatively, the rate controller 207 can store the adjusted coding parameters 229 in an storage 231 and the encoder 203 can retrieve the stored adjusted coding parameters from the storage 231.

According to some examples, the input information 223 can include information associated with the encoder input data 213. For example, the input information 223 can include any characteristics of the encoder input data 213 that can be used for rate control, such as, but not limited to, resolution, size, image complexity, texture, luminance, chrominance, motion information, or other similar characteristics. For example higher complex input data can be encoded with a higher bit rate than less complex input data.

According to some examples, the output information 225 can include information associated with the encoded data 215. For example, the output information 225 can include any characteristics of the encoded data 215 that can be used for rate control, such as, but not limited to, size, a PSNR value associated with the encoded data 215, error rate, or other similar characteristics.

According to some examples, the encoder information 227 can include information associated with the encoded data 215. For example, the encoder information 227 can include, but is not limited to, a number of bits used to encode a data unit (e.g., a frame, a slice, a macroblock), the bit rate associated with the encoded data 215, parameters used to encode the data unit, encoder resource information (e.g., CPU/memory usage, buffer usage), or other similar characteristics. It is noted that although the output information 225 and the encoder information 227 are illustrated as different inputs to the rate controller 207, they can have overlapping information.

Additionally or alternatively, the rate controller 207 can also receive transmission information 219 from, for example, transceiver 205 to use for adjusting the coding parameters. According to some embodiments, the transmission information 219 can include any characteristics of the transceiver 205 or the communication channel (on which the encoded data 215 is transmitted) that can be used for rate control, such as, but not limited to, a bandwidth associated with the communication channel, feedback information received by the transceiver 205 (e.g., SNR associated with the channel, channel error(s), a distance to a receiver device associated with system 200, parameters associated with the receiver device, playback quality at the receiver device, etc.), parameters associated with the transceiver 205 used to transmit the encoded data 215, or other similar characteristics.

In some embodiments, in addition to the information 219, 223, 225, or 227, the rate controller 207 can use one or more thresholds to adjust the coding parameters to control the bit rate of the encoded data 215. In some examples, the thresholds can be stored in, for example, the storage 231 and can be retrieved by the rate controller 207. The values of the threshold can be predetermined or be dynamically updated by a user, by a system administrator, by the rate controller 207, or other components/devices, according to some embodiments. The thresholds stored in storage 231 can include, but are not limited to, threshold(s) or range(s) associated with the bit rate, threshold(s) or range(s) associated with the coding parameters, threshold(s) or range(s) associated with the preprocessing circuitry 201, or similar threshold(s) or range(s).

According to some embodiments, the rate controller 207, based on the received input information, adjusts the coding parameters of the encoder 203 such that the bit rate associated with the encoded data 215 is within a predetermined range or close (or substantially close) to a target bit rate. In some examples, the predetermined range or the target bit rate are (or are determined based on) a bandwidth associated with the communication channel. After adjusting the coding parameters of the encoder 203, the rate controller 207 is configured to determine whether the adjusted coding parameters are within an acceptable range for the coding parameters. If the adjusted coding parameters are within the acceptable range, the system 200 continues the process of encoding the next input data and rate control. However, if the adjusted coding parameters are not within the acceptable range, the rate controller 207 is configured to instruct the preprocessing circuitry 201 to preprocess the next input data 211. Additionally, the rate controller 207 is configured to adjust one or more parameters of the preprocessing circuitry 201. The instructions to preprocess the next input data and/or the adjusted parameters 221 of the preprocessing circuitry 201 are sent to the preprocessing circuitry 201.

In addition to or alternative to using the quantization parameter as the one or more state parameters of system 200, PSNR value(s) of prior input data (e.g., one or more images received prior to the input data 211) can be used to trigger preprocessing and/or adjusting one or more parameters of the preprocessing circuitry 201. In this example, the rate controller 207 can determine a PSNR value associated with prior input data and/or the encoded data 215 and compare the determined PSNR value with a PSNR threshold. In response to the determined PSNR value being equal to or less than a PSNR threshold, the rate controller 207 can instruct the preprocessing circuitry 201 to preprocess the next input data and/or adjust one more parameters associated with the preprocessing circuitry 201. For example, the rate controller 207 can be configured to compare data obtained from decoding the encoded data 215 with the encoder input data 213 to determine the PSNR value. Additionally or alternatively, the rate controller 207 can receive the PSNR value associated with the encoder 203 in the encoder information 227. In some examples, the PSNR value can be an average PSNR determined over a period of time encoding data by encoder 203. In some examples, the PSNR value associated with the encoder 203 can be the PSNR value determined for the encoded data 215. The rate controller 207 can compare the determined PSNR value with PSNR threshold. In some examples, the PSNR threshold is stored in storage 231. In response to the determined PSNR value being equal to or less than the PSNR threshold, the rate controller 207 is configured to instruct the preprocessing circuitry 201 to preprocess the next input data 211. Additionally, the rate controller 207 is configured to adjust one or more parameters of the preprocessing circuitry 201. The instructions to preprocess the next input data and/or the adjusted parameters 221 of the preprocessing circuitry 201 are sent to the preprocessing circuitry 201.

In addition to or alternative to using the quantization parameter and/or the PSNR as the one or more state parameters of system 200, an occupied storage space(s) in one or more buffers used to store encoded data 215 can be used to trigger preprocessing and/or adjusting one or more parameters of the preprocessing circuitry 201. In this example, the rate controller 207 can determine the occupied storage space(s) in one or more buffers associated with the encoder 203 and/or the transceiver 205 and compare the determined storage space(s) in one or more buffers with a threshold. In response to the determined storage space(s) in one or more buffers being equal to or greater than a threshold, the rate controller 207 can instruct the preprocessing circuitry 201 to preprocess the next input data and/or adjust one more parameters associated with the preprocessing circuitry 201. For example, the rate controller 207 can be configured to compare the encoded data 215 with the encoder input data 213 to determine the storage space(s) in one or more buffers associated with the encoder 203. Additionally or alternatively, the rate controller 207 can receive the storage space(s) in one or more buffers associated with the encoder 203 in the encoder information 227. In some examples, the storage space(s) in one or more buffers associated with the encoder 203 can be an average storage space determined over a period of time and/or over a number of buffer. In some examples, the rate controller 207 can receive the storage space(s) in one or more buffers associated with the transceiver 205 in the transmission information 219. The rate controller 207 can compare the determined storage space(s) in one or more buffers with a threshold. In some examples, the threshold is stored in storage 231. In response to the determined storage space(s) in one or more buffers being equal to or greater than the threshold, the rate controller 207 is configured to instruct the preprocessing circuitry 201 to preprocess the next input data 211. Additionally, the rate controller 207 is configured to adjust one or more parameters of the preprocessing circuitry 201. The instructions to preprocess the next input data and/or the adjusted parameters 221 of the preprocessing circuitry 201 are sent to the preprocessing circuitry 201.

FIG. 2B is a block diagram depicting an example of the preprocessing circuitry 201, according to some embodiments. As illustrated in FIG. 2B, the preprocessing circuitry 201 can include spatial frequency control 241, color control 243, and brightness control 245, according to some examples. Although the spatial frequency control 241, the color control 243, and the brightness control 245 are illustrated as separate circuits, they can be combined into one or more circuits. Further, the preprocessing circuitry 201 can include other circuits.

As discussed with respect to FIG. 2A, the preprocessing circuitry 201 can receive the input data 211 and generate the encoder input data 213. According to some examples, the preprocessing circuitry 211 can receive an instruction from the rate controller 207 to preprocess the input data 211 to generate the encoder input data 213. If the preprocessing circuitry 211 does not receive any instructions for preprocessing, the preprocessing circuitry 211 can pass the input data 211 as the encoder input data 213 without preprocessing the input data 211, in some embodiments.

Additionally, the preprocessing circuitry 211 receives adjusted parameters 221 from the rate controller 207. According to some embodiments, the adjusted parameters 221 are the parameters associated with one or more of the spatial frequency control 241, the color control 243, and the brightness control 245.

The input data 211 is input to one or more of the spatial frequency control 241, the color control 243, and the brightness control 245 such that the input data 211 is preprocessed before it is encoded by the encoder 203. As discussed above, for example, preprocessing the input data 211 can include adjusting one or more imaging parameters of the input data 211. According to some examples, the one or more imaging parameters can include, but are not limited to, a spatial frequency of an image, a dimensionality of a color space of an image, and/or a dimensionality of a brightness space of an image. Adjusting one or more imaging parameters of the input data 211 can include reducing the one or more imaging parameters of the input data 211 that can result in the encoder input data 213 having less quality than input data 211, according to some embodiments.

According to some examples, the spatial frequency control 241 can include a filter configured to control the spatial frequency of the input data 211. For example, the spatial frequency control 241 can include a bilateral filter configured to control the spatial frequency of the input data 211 by, for example, controlling one or more Gaussian kernel sigma parameters—a spatial scale parameter and a value scale parameter. In this example, the bilateral filter is configured to reduce the noise associated with the input data 211. The bilateral filter can be a non-linear filter configured to smooth the input data 211.

By using the bilateral filter, the input data 211 can be smoothed while the edges associated with the input data 211 is preserved. The bilateral filter replaces an intensity of each pixel within a frame of the input data 211 with a weighted average of intensity values from nearby pixels of the frame. In some examples, this weight can be based on a Gaussian distribution. In some examples, the weights can depend on the distance (e.g., Euclidean distance) between the pixels of the frame within the input data 211. Additionally or alternatively, the weights of the bilateral distance can depend on the radiometric differences between pixels of the frame of the input data 211 (e.g., range differences, such as color intensity, depth distance, etc.)

As one example of the bilateral filter, a pixel (i,j) of the frame of the input data 211 can be filtered by using spatial distances of the pixel and its neighboring pixel(s) and also intensity differences between the pixel and its neighboring pixel(s). For example, considering the pixel (i,j) and one its neighboring pixel (k,l) of the frame of the input data 211, a weight assigned to pixel (k,l) to filter (e.g., denoise) pixel (i,j) is given by:

$$w ( i , j , k , l ) = exp ( - \frac{{( i - k )}^{2} + {( j - l )}^{2}}{2 {σ}_{d}^{2}} - \frac{{‖ f ( i , j ) - f ( k , l ) ‖}^{2}}{2 {σ}_{r}^{2}} )$$

Here, f is the intensity of the pixel in the original frame of the input data 211. Also, σ_{d} (spatial scale parameter) and σᵣ (value scale parameter) are the smoothing parameters of the bilateral filter.

After the bilateral filter is applied to the pixel (i,j) using its neighboring pixel(s), the filtered (e.g., denoised) intensity of the pixel (i,j) is determined as below:

$$g ( i , j ) = \frac{{Σ}_{k , l} f ( k , l ) w ( i , j , k , l )}{{Σ}_{k , l} w ( i , j , k , l )}$$

Here, g(i,j) is the filtered (e.g., denoised) intensity of the pixel (i,j) of the frame of the input data 211 over the neighboring pixel(s) (k,l) of the frame of the input data 211.

The bilateral filter, as one example of the spatial frequency control 241, of the preprocessing circuitry 201 is configured to preprocess the input data 211. As discussed in more detail below, the rate control 207 is configured to control the parameters of the filter 241 (e.g., σ_{d} (spatial scale parameter) and σᵣ (value scale parameter) of the bilateral filter) based on the one or more state parameters associated with system 200 (e.g., quantization parameter, PSNR, storage space in a buffer, etc.) Although the bilateral filter is discussed as one example of the spatial frequency control 241, the embodiments of this disclosure are not limited to this examples and other filters can be used as the spatial frequency control 241.

In addition to the spatial frequency control 241, the preprocessing circuitry 201 can include the color control 243 and the brightness control 245, according to some embodiments. The color control 243 can be configured to control a dimensionality of a color space associated with the input data 211 and the brightness control can be configured to control a dimensionality of a brightness space associated with the input data 211, in some examples.

According to some examples, the color control 243 can be configured to adjust the dimensionality of the color space associated with the input data 211 by a preset value. This preset value can be stored in a storage in (and/or accessible by) the preprocessing circuitry 201 and/or storage 231. As a non-limiting example, the input data 211 can include a color space including 256 orders. The color control 243 can be configured to reduce the order of the color space based on the control signal (e.g., adjusted parameters 221) from the rate control 207. In one example, the color control 243 can reduce the dimensionality of the color space by a power of two in each iteration (e.g., 256 to 128 to 64 to 32 to 16 to 8 to 4 to 2 to 1.) By reducing the dimensionality of the color space using the preprocessing circuitry 201 and the rate control 207, the number of bits used to encode the encoder input data 213 can be reduced and therefore, the bit rate associated with the encoded data 215 can be controlled, in some examples.

According to some embodiments, the color control 243 can be configured to adjust the dimensionality of the brightness space associated with the input data 211 by a preset value. This preset value can be stored in a storage in (and/or accessible by) the preprocessing circuitry 201 and/or storage 231. As a non-limiting example, the input data 211 can include a brightness space including 256 orders. The brightness control 245 can be configured to reduce the dimensionality of the brightness space based on the control signal (e.g., adjusted parameters 221) from the rate control 207. In one example, the brightness control 245 can reduce the dimensionality of the brightness space by a power of two in each iteration (e.g., 256 to 128 to 64 to 32 to 16 to 8 to 4 to 2 to 1.) By reducing the dimensionality of the brightness space using the preprocessing circuitry 201 and the rate control 207, the number of bits used to encode the encoder input data 213 can be reduced and therefore, the bit rate associated with the encoded data 215 can be controlled, in some examples.

The dimensionality of color and brightness spaces are provided as examples and the embodiments of this disclosure are not limited to these example. Other number of dimensionalities and other schemes for controlling the dimensionalities can be used.

According to some examples, one or more of the spatial frequency control 241, the color control 243, and the brightness control 245 can be applied to the input data 211 to generate encoder input data 213. One or more of the spatial frequency control 241, the color control 243, and the brightness control 245 are used to adjust one or more imaging parameters of the input data 211. According to some examples, applying the spatial frequency control 241, the color control 243, and the brightness control 245 to the input data 211 can be done hierarchically and based on a preset priority. In one example, the spatial frequency control 241 can have the highest priority. In this example, the spatial frequency control 241 is applied first to the input data 211, then, if needed, the color control 243 and the brightness control 245 are applied. However, this is one example and other orders for applying the spatial frequency control 241, the color control 243, and the brightness control 245 (and/or other control mechanism) for adjust one or more imaging parameters of the input data 211 can be applied.

Similarly, controlling (e.g., adjusting) the parameters of the spatial frequency control 241, the color control 243, and the brightness control 245 can be done hierarchically. For example, the rate control 207 is configured to first control the parameters of the spatial frequency control 241 based on the one or more state parameters of system 200. After the parameters of the spatial frequency control 241 reach one or more thresholds, then the rate controller 207 can control the parameters of the color control 243 based on the one or more state parameters of system 200. After the parameters of the color control 243 reach one or more thresholds, then the rate controller 207 can control the parameters of the brightness control 245 based on the one or more state parameters of system 200. The order of the control of the spatial frequency control 241, the color control 243, and the brightness control 245 is provided as one example, and other orders can be used for controlling these circuits.

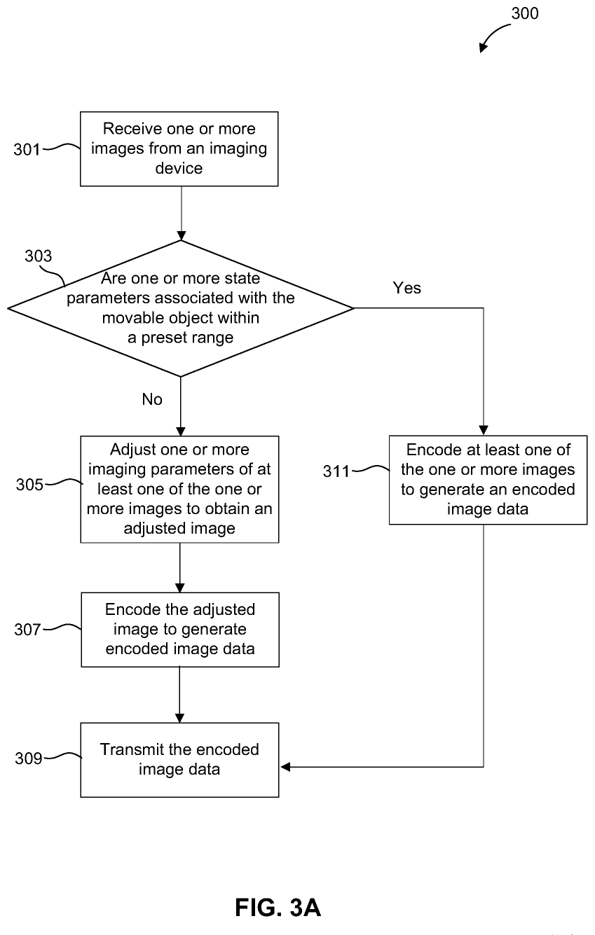

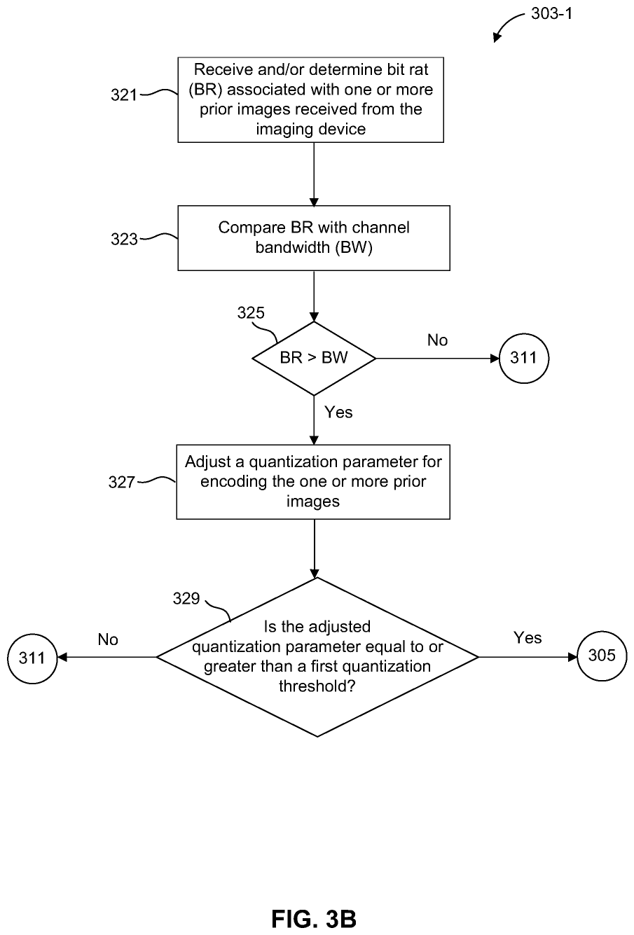

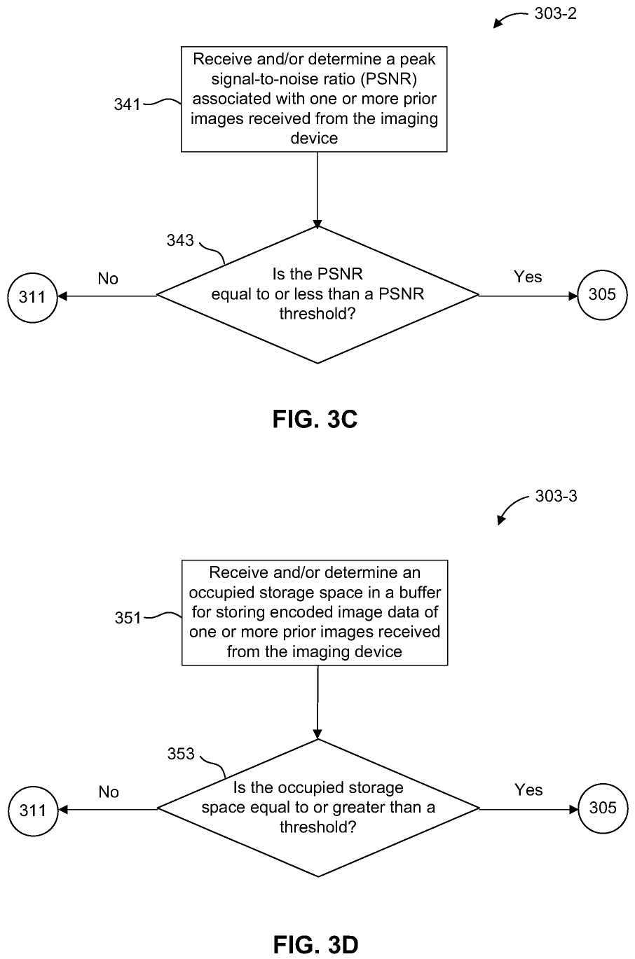

FIG. 3A is a flowchart depicting an example method 300 for preprocessing, according to some embodiments. For convenience, FIG. 3A will be described with references to FIGS. 1, 2A, and 2B, but method 300 is not limited to the specific embodiments depicted in those figures and other systems may be used to perform the method as will be understood by those skilled in the arts. It is to be appreciated not all steps may be needed, and the steps may not be performed in the same order as shown in FIG. 3A.

According to some examples, method 300 begins at 301 when the preprocessing circuitry 201 receives input data 211. Input data 211 can include one or more images (e.g., one or more frames of video data) captured by the imaging device 202 of system 200. At 303, a determination is made whether one or more state parameters associated with system 200 are within a preset range. According to some examples, this determination can be made by the preprocessing circuitry 201. Additionally or alternatively, the determination can be made by the rate controller 207.

According to some embodiments, the one or more state parameters associated with system 200 can include a quantization parameter of the encoder 203. This quantization parameter can include a quantization parameter used for encoding prior input data (e.g., one or more images received prior to the input data 211.) Additionally or alternatively, this quantization parameter can include an adjusted quantization parameter obtained by adjusting a quantization parameter used for encoding one or more images received prior to the input data 211, where the adjustment can be made based, at least, on bandwidth of a communication channel (e.g., communication channel 105 of FIG. 1). For example, the preprocessing circuitry 201 (alone or in combination with the rate controller 207) can determine whether the quantization parameter of the encoder 203 used for encoding prior input data is equal to or greater than a first quantization parameter threshold. Additionally or alternatively, the one or more state parameters associated with system 200 can include PSNR value(s) of prior input data (e.g., one or more images received prior to the input data 211.) For example, the preprocessing circuitry 201 can determine whether the PSNR value(s) of prior input data is equal to or less than a PSNR threshold. In addition to or alternative to the quantization parameter and/or the PSNR value, the one or more state parameters associated with system 200 can include an occupied storage space(s) in one or more buffers used to store encoded data associated with prior input data (e.g., one or more images received prior to the input data 211.) For example, the preprocessing circuitry 201 can determine whether the occupied storage space(s) in one or more buffers used to store encoded data associated with prior input data is equal to or greater than a threshold.

If the preprocessing circuitry 201 (alone or in combination with the rate controller 207) determines that the one or more state parameters associated with system 200 are within the preset range, at 311 encoder 203 encodes at least one of the one or more images in the input data 211 to generate encoded image data (encoded data 215.) Since the one or more state parameters associated with system 200 are within the preset range, the preprocessing circuitry 201 does not preprocess the at least one of the one or more images in the input data 211, according to some embodiments. At 309, the transceiver 205 transmits the encoded image data.

However, if the preprocessing circuitry 201 (alone or in combination with the rate controller 207) determines that the one or more state parameters associated with system 200 are not within the preset range, at 305 the preprocessing circuitry 201 preprocess at least one of the one or more images in the input data 211. According to some examples, the preprocessing at 305 can include adjusting one or more imaging parameters of the at least one of the one or more images to obtain an adjusted image (the encoder input data 213 of FIG. 2A.)

According to some embodiments, adjusting the one or more imaging parameters at 305 can include reducing the one or more imaging parameters of the at least one of the one or more images in the input data 211 to generate the adjusted image (the encoder input data 213 of FIG. 2A.) Reducing the one or more imaging parameters can result in reducing the quality of the at least one of the one or more images in the input data 211. According to some examples, the one or more imaging parameters can include, but are not limited to, a spatial frequency, a dimensionality of a color space, and/or a dimensionality of a brightness space of the at least one of the one or more images.

Adjusting the one or more imaging parameters at 305 can include adjusting the spatial frequency of the at least one of the one or more images using a filter (e.g., a bilateral filter.) Further, the adjusting at 305 can include adjusting one or more configuration parameters (e.g., a spatial scale parameter, a value scale parameter, etc.) of the filter. In some examples, adjusting the one or more configuration parameters can be based on a preset order.

Additionally or alternatively, adjusting the one or more imaging parameters at 305 can include adjusting the dimensionality of the color space of the at least one of the one or more images using, for example, a preset value. Also, adjusting the one or more imaging parameters at 305 can include adjusting the dimensionality of the brightness space of the at least one of the one or more images using, for example, a preset value.

It is noted that adjusting the one or more imaging parameters at 305 can include adjusting one imaging parameter, adjusting two imaging parameters, adjusting three imaging parameter, or adjusting any number of the imaging parameters. Further, adjusting the one or more imaging parameters at 305 can include adjusting the imaging parameters based on a preset priority. As a non-limiting example, adjusting the spatial frequency can have the highest priority followed by adjusting the dimensionality of the color space, and followed by adjusting the dimensionality of the brightness space. However, any other order and preset priority can also be used.

After the at least one of the one or more images of the input data 211 is preprocessed at 305 to generate the adjusted image (the encoder input data 213), the encoder 203 encodes the adjusted image (the encoder input data 213) to generate the encoded image data (the encoded data 215.) At 309, the transceiver 205 transmits the encoded image data. This encoded image data can be from 307 or 311.

FIGS. 3B-3D are flowcharts depicting example methods for implementing step 303 of method 300 of FIG. 3A, according to some embodiments. For convenience, FIGS. 3B-3D will be described with references to FIGS. 1, 2A, and 2B, but methods 303-1 of FIG. 3B, 303-2 of FIG. 3C, and 303-3 of FIG. 3D are not limited to the specific embodiments depicted in those figures and other systems may be used to perform the method as will be understood by those skilled in the arts. It is to be appreciated not all steps may be needed, and the steps may not be performed in the same order as shown in FIGS. 3B-3D.

According to some embodiments, the one or more state parameters associated with system 200 used in the determination of 303 of FIG. 3A can include a quantization parameter of the encoder 203. This quantization parameter can include a quantization parameter used for encoding prior input data (e.g., one or more images received prior to one or more images received at 301 of FIG. 3A.) Additionally or alternatively, this quantization parameter can include an adjusted quantization parameter obtained by adjusting a quantization parameter used for encoding one or more images received prior to one or more images received at 301 of FIG. 3A, where the adjustment can be made based, at least, on bandwidth of a communication channel (e.g., communication channel 105 of FIG. 1). For example, the preprocessing circuitry 201 (alone or in combination with the rate controller 207) can determine to preprocess the input data 211 if the quantization parameter of the encoder 203 used for encoding prior input data is equal to or greater than a first quantization parameter threshold, as illustrated in method 303-1 of FIG. 3B.

At 321, the rate controller 207 is configured to receive and/or determine the bit rate associated with one or more images that were encoded before the one or more images received at 301 of FIG. 3A. As discussed above with respect to FIG. 2A, the rate controller 207 is configured to receive one or more of transmission information 219, input information 223, output information 225, and encoder information 229. In some examples, these received information can include the bit rate associated with one or more images that were previously encoded. Additionally or alternatively, the bit controller 207 can use the received information to determine the bit rate associated with one or more images that were previously encoded.

In one exemplary embodiment, the rate controller 207 is configured to determine the bit rate associated with previously transmitted encoded data using the transmission information 219. For example, the transmission information 219 can include a feedback signal received from the receiver device 103 of FIG. 1. The feedback signal is in response to the previously encoded data received at the receiver device 103, according to some examples, The rate controller 207 can receive the feedback signal and the feedback information from the receiver device 103 through the transceiver 205. Using the received feedback signal, the rate controller 207 can determine a quality of the previously transmitted encoded data 215 as received by the receiver device 103 or can determine an approximate distance between the system 200 to the receiver device 103. In this example, the rate controller 207 can determine the bit rate associated with the previously transmitted encoded data based on the determined quality and/or the determined approximate distance.

At 323, the rate controller 207 is configured to compare the bit rate with one or more thresholds. For example, the rate controller 207 is configured to control the encoder 203 such that the bit rate is within a range (e.g., less than a maximum value and greater than a minimum value.) In another example, the rate controller 207 is configured to control the encoder 203 such that the bit rate is close to a target value (e.g., an average target bit rate.) In this example, the rate controller 207 is configured to control the encoder 203 such that the bit rate is less than a channel bandwidth associated with the communication channel on which the encoded data 215 is transmitted. The rate controller 207 can receive or determine the channel bandwidth based on, for example, the output information 225 or the transmission information 219.

At 325, the rate controller 207 determines whether the bit rate associated with the one or more previously encoded data is within the predetermined range or less than the target bit rate. For example, the rate controller 207 determines whether the bit rate is greater than the channel bandwidth. If the bit rate is not greater (i.e., less than or equal to) than the channel bandwidth, method 303-1 of FIG. 3B returns to 311 of method 300 of FIG. 3A. However, if the bit rate is greater than the channel bandwidth, the method continues to 327.

At 327, the rate controller 207 adjusts one or more coding parameters (parameters associated with the encoder 203) based on the determined bit rate and the predetermined range of bit rate or the target bit rate using a bit rate control algorithm. In some examples, the one or more coding parameters include one or more quantization parameters of the encoder 203. The bit rate control algorithm can include any algorithm for adjusting one or more coding parameters based on the determined bit rate and one or more thresholds associated with the bit rate. For example, the bit rate control algorithm can include models where, for example, the bit rate is a function of one or more coding parameters (e.g., the quantization parameter) and therefore, the one or more coding parameters (e.g., the quantization parameter) can be adjusted based on a comparison between the bit rate and the one or more thresholds associated with the bit rate. However, the embodiments of this disclosure are not limited to this example, and other models and algorithms for bit rate control can be used.

At 329, the rate controller 207 compares the adjusted quantization parameter with a first quantization parameter threshold to determine whether the adjusted quantization parameter is equal to or greater than the first quantization parameter threshold. Method 303-1 of FIG. 3B continues at 305 of method 303 of FIG. 3A to preprocess the at least one of the one or more images received at 301 of FIG. 3A if the quantization parameter of the encoder 203 used for encoding prior input data is equal to or greater than the first quantization parameter threshold. However, method 303-1 of FIG. 3B continues at 311 of method 303 of FIG. 3A if the quantization parameter of the encoder 203 used for encoding prior input data is less than the first quantization parameter threshold.

According to some embodiments, the one or more state parameters associated with system 200 used in the determination of 303 of FIG. 3A can include PSNR value(s) of prior input data (e.g., one or more images received prior to one or more images received at 301 of FIG. 3A.) For example, the preprocessing circuitry 201 (alone or in combination with the rate controller 207) can determine to preprocess the input data 211 if the PSNR value(s) of prior input data is equal to or less than a PSNR threshold, as illustrated in method 303-2 of FIG. 3C.

At 341, the rate controller 207 (alone or in combination with the preprocessing circuitry 201) is configured to receive and/or determine the PSNR value associated with one or more images that were encoded before the one or more images received at 301 of FIG. 3A. In some examples, the rate controller 207 can determine the PSNR value associated with the encoder 203 and/or associated with one or more images that were encoded before the one or more images received at 301. For example, the rate controller 207 can be configured to compare data obtained from decoding previously encoded one or more images with their corresponding previously received one or more images to determine the PSNR value. Additionally or alternatively, the rate controller 207 can receive the PSNR value in the encoder information 227. In some examples, the PSNR value can be an average PSNR determined over a period of time encoding data by the encoder 203.

At 343, the rate controller 207 (alone or in combination with the preprocessing circuitry 201) compares the PSNR value with a PSNR threshold to determine whether the PSNR value is equal to or less than the PSNR threshold. Method 303-2 of FIG. 3C continues at 305 of method 303 of FIG. 3A to preprocess the at least one of the one or more images received at 301 of FIG. 3A if the PSNR value is equal to or less than the PSNR threshold. However, method 303-2 of FIG. 3C continues at 311 of method 303 of FIG. 3A if the PSNR value is greater than the PSNR threshold.

According to some embodiments, the one or more state parameters associated with system 200 used in the determination of 303 of FIG. 3A can include an occupied storage space(s) in one or more buffers used to store encoded data associated with prior input data (e.g., one or more images received prior to one or more images received at 301 of FIG. 3A.) For example, the preprocessing circuitry 201 (alone or in combination with the rate controller 207) can determine to preprocess the input data 211 if the occupied storage space(s) in one or more buffers used to store encoded data associated with prior input data is equal to or greater than a threshold, as illustrated in method 303-2 of FIG. 3C.

At 351, the rate controller 207 (alone or in combination with the preprocessing circuitry 201) is configured to receive and/or determine the occupied storage space(s) in one or more buffers used to store encoded data associated with prior input data that were encoded before the one or more images received at 301 of FIG. 3A. For example, the rate controller 207 can be configured to compare the previously encoded data with the corresponding previously receive input data to determine the storage space(s) in one or more buffers associated with the encoder 203. Additionally or alternatively, the rate controller 207 can receive the storage space(s) in one or more buffers associated with the encoder 203 in the encoder information 227. In some examples, the storage space(s) in one or more buffers associated with the encoder 203 can be an average storage space determined over a period of time and/or over a number of buffer. In some examples, the rate controller 207 can receive the storage space(s) in one or more buffers associated with the transceiver 205 in the transmission information 219.

At 353, the rate controller 207 (alone or in combination with the preprocessing circuitry 201) compares the occupied storage space(s) in one or more buffers with a threshold to determine whether the occupied storage space(s) in one or more buffers is equal to or greater than the threshold. Method 303-3 of FIG. 3D continues at 305 of method 303 of FIG. 3A to preprocess the at least one of the one or more images received at 301 of FIG. 3A if the occupied storage space(s) in one or more buffers is equal to or greater than the threshold. However, method 303-3 of FIG. 3D continues at 311 of method 303 of FIG. 3A if the occupied storage space(s) in one or more buffers is less than the threshold.

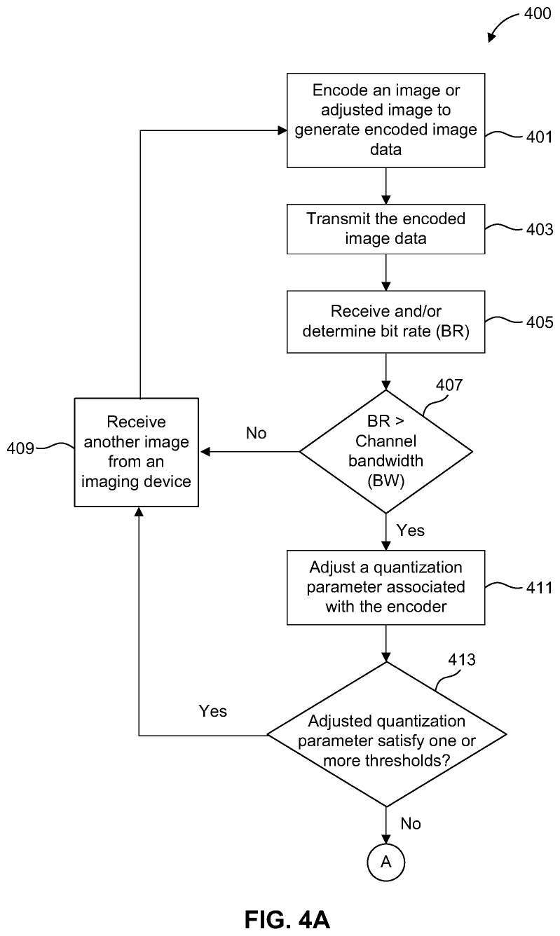

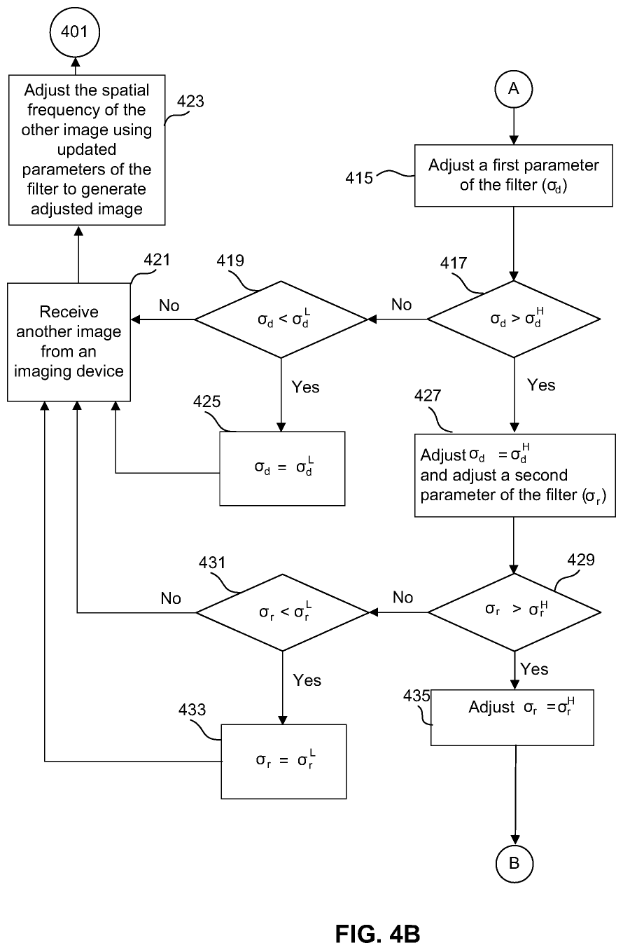

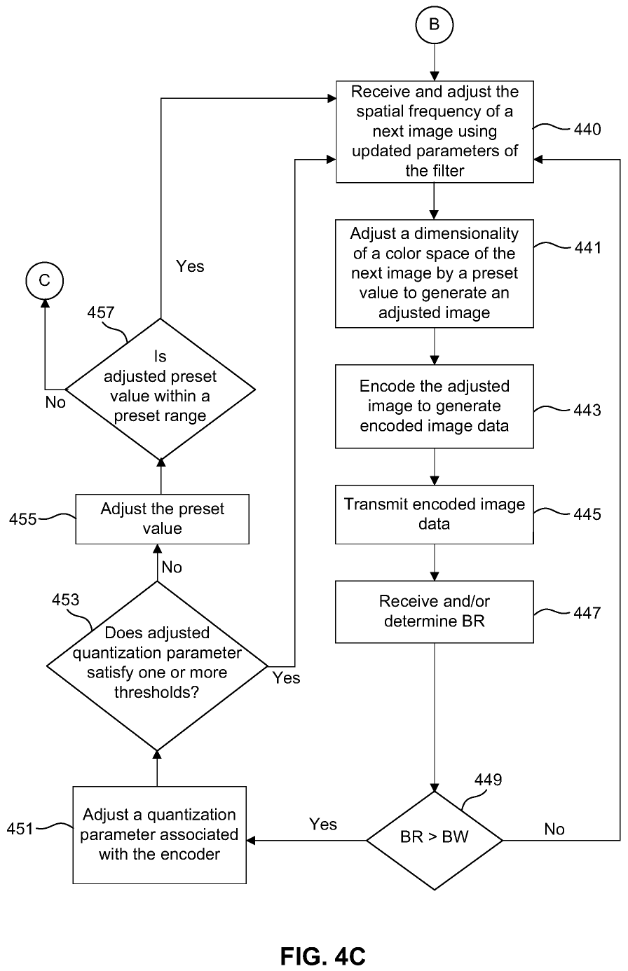

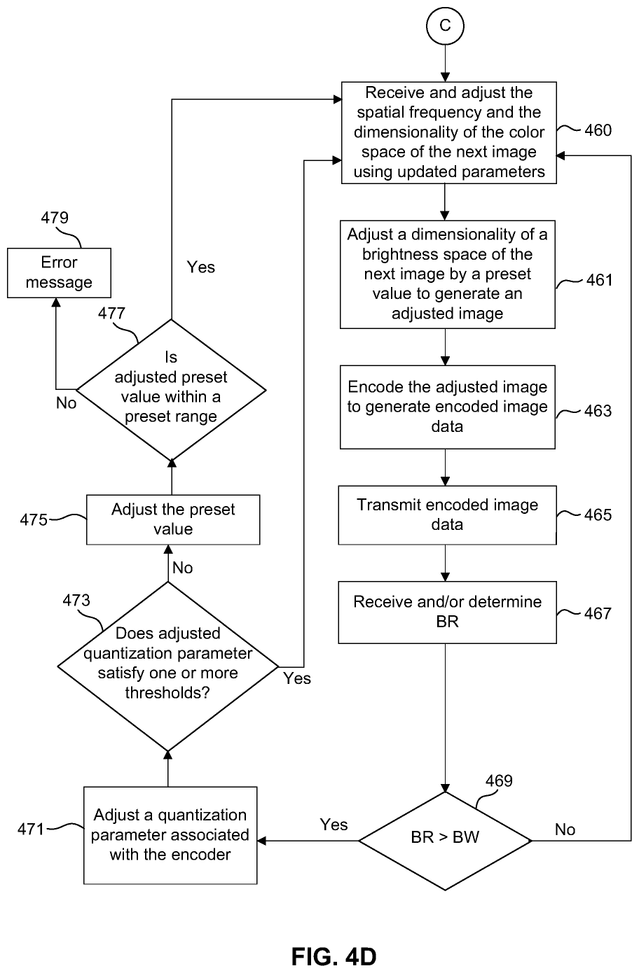

FIGS. 4A-4D are flowcharts depicting an example method, according to some embodiments. For convenience, FIGS. 4A-4D will be described with references to FIGS. 1, 2A, and 2B, but method 400 of FIGS. 4A-4D is not limited to the specific embodiments depicted in those figures and other systems may be used to perform the method as will be understood by those skilled in the arts. It is to be appreciated not all steps may be needed, and the steps may not be performed in the same order as shown in FIGS. 4A-4D.

It is noted that although FIGS. 4A-4D are discussed with respect to bit rate control and quantization parameter as one of the state parameters of system 200, the method of FIGS. 4A-4D can be performed using other state parameters of system 200 as discussed before. Also, although FIGS. 4A-4D are discussed as adjusting the spatial frequency of an image first, then adjusting the dimensionality of the color space of the image, and then adjusting the dimensionality of the brightness space of the image, the method of FIGS. 4A-4D can adjust one or more imaging parameters of the image using different parameters and/or different order of the parameters.

According to some examples, method 400 begins at 401 when the encoder 203 encodes one or more images or one or more adjusted images in the encoder input data 213 to generate encoded image data (encoded data 215.) In some examples, one or more images or one or more adjusted images in the encoder input data 213 includes one or more frames of video data. The one or more images or the one or more adjusted images are received from, for example, the imaging device 202 or the preprocessing circuitry 201 of system 200 of FIG. 2.

At 403, the encoded image data (the encoded data 215) is transmitted using, for example, the transceiver 205. The encoded data 215 is transmitted over a communication channel to, for example, the receiver device 103 of FIG. 1, according to some examples.

At 405, the rate controller 207 (alone or in combination with preprocessing circuitry 201—herein referred to as the rate controller 207) is configured to receive or determine the bit rate associated with the encoded image data (encoded data 215.)

At 407, the rate controller 207 is configured to compare the bit rate with one or more thresholds. For example, the rate controller 207 is configured to control the encoder 203 such that the bit rate is within a range (e.g., less than a maximum value and greater than a minimum value.) In another example, the rate controller 207 is configured to control the encoder 203 such that the bit rate is close to a target value (e.g., an average target bit rate.) In this example, the rate controller 207 is configured to control the encoder 203 such that the bit rate is less than a channel bandwidth associated with the communication channel on which the encoded data 215 is transmitted. The rate controller 207 can receive or determine the channel bandwidth based on, for example, the output information 225 or the transmission information 219. At 407, the rate controller 207 further determines whether the bit rate associated with the encoded image data (encoded data 215) is within the predetermined range or less than the target bit rate. For example, the rate controller 207 determines whether the bit rate is greater than the channel bandwidth. If the bit rate associated with the encoded data 215 is not greater (i.e., less than or equal to) than the channel bandwidth, method 400 continues to 409.

At 409, the preprocessing circuitry 201 receives a next image (e.g., a next frame) within the input data 211 and method 400 continues at 401. In some examples, the preprocessing circuitry 201 does not preprocess the next image at 409.

However, if the bit rate associated with the encoded image data (encoded data 215) is greater than the channel bandwidth, the method continues to 411. At 411, the rate controller 207 adjusts one or more coding parameters (parameters associated with the encoder 203) based on the determined bit rate and the predetermined range of bit rate or the target bit rate using a bit rate control algorithm. In some examples, the one or more coding parameters include one or more quantization parameters of the encoder 203.

At 413, the rate controller 207 compares the adjusted one or more coding parameters with one or more thresholds. In some examples, the adjusted coding parameter includes an adjusted quantization parameter. For example, the adjusted quantization parameter can be a value within a certain range (e.g., between and including a lower threshold of Q^{L} and an upper threshold of Q^{H}.) At 413, the rate controller 207 compares the adjusted quantization parameter with, for example, the lower threshold of Q^{L} and the upper threshold of Q^{H}. At 413, the rate controller 207 determines whether the adjusted coding parameters satisfy the one or more thresholds. For example, the rate controller 207 determines whether the adjusted quantization parameters is within the predetermined range (e.g., between the lower threshold of Q^{L} and the upper threshold of Q^{H}.)

If the rate controller 207 determines that the adjusted coding parameters satisfy the one or more thresholds, the method continues at 409, where the preprocessing circuitry 201 receives a next image (e.g., a next frame) within the input data 211 and method 400 continues at 401. In some examples, the preprocessing circuitry 201 does not preprocess the next image at 409.

However, if, at 413, the rate controller 207 determines that the one or more coding parameters do not satisfy the one or more predetermined threshold, the rate controller 207 can adjust the spatial frequency of the image and/or adjust one or more configuration parameters of the spatial frequency control 241 (e.g., a filter) used for adjusting the spatial frequency of the image. For example, at 415 the rate controller 207 is configured to adjust a first parameter of the filter 241 of the preprocessing circuitry 201. In one example, the first parameter of the filter 241 is σ_{d} (spatial scale parameter). For example, the rate controller 207 is configured to adjust the spatial scale parameter (σ_{d} ) by a preset value (e.g., by adding a spatial scale step size to the spatial scale parameter (σ_{d}) or by subtracting a spatial scale step size from the spatial scale parameter (σ_{d}).) According to some examples, if the adjusted quantization parameter determined at 411 is greater than the upper threshold of Q^{H}, then the rate controller 207 is configured to adjust the spatial scale parameter (σ_{d}) by adding the spatial scale step size to the spatial scale parameter (σ_{d}). In some examples, if the adjusted quantization parameter determined at 411 is less than the lower threshold of Q^{L}, then the rate controller 207 is configured to adjust the spatial scale parameter (σ_{d}) by subtracting the spatial scale step size from the spatial scale parameter (σ_{d}). In these examples the spatial scale step size can be stored in storage 231 where the rate controller 207 can access. It is noted that other methods can be used to adjust the spatial scale parameter (σ_{d}). As one example, a set of spatial scale parameters (σ_{d}) can be stored in, for example, storage 231 where the rate controller 207 can choose from when the spatial scale parameter (σ_{d}) is to be adjusted.

After adjusting the spatial scale parameter (σ_{d}), the rate controller 207 can compare the adjusted spatial scale parameter (σ_{d}) with one or more thresholds at 417 and 419. In one example, the rate controller 207 can compare the adjusted spatial scale parameter (σ_{d}) with a lower threshold (σ_{d}^{L}) and/or a higher threshold (σ_{d}^{H}). At 419, if the adjusted spatial scale parameter (σ_{d}) is still within the range defined by the lower threshold (σ_{d}^{L}) and the higher threshold (σ_{d}^{H}) (σ_{d}^{L}≤σ_{d}≤σ_{d}^{H}), the bit rate controller 207 can communicate the adjusted spatial scale parameter (σ_{d}) to the spatial frequency control 241 (e.g., filter) of the preprocessing circuitry 201. Method 400 then can continue at 421 and 423. In this example, at 421 the preprocessing circuitry 201 receives a next image (e.g., a next frame of a video) within the input data 211 from the imaging device 202. At 423, the preprocessing circuitry 201 adjusts the configuration parameter(s) of the spatial frequency control 241 (e.g., filter) and adjust the spatial frequency of the received next image using the updated configuration parameters (e.g., the adjusted spatial scale parameter (σ_{d}).) Then method 400 returns to 401.

At 419, if the adjusted spatial scale parameter (σ_{d}) is less than or equal to the higher threshold (σ_{d}^{H}) and is also less that the lower threshold (σ_{d}^{L}) (σ_{d}<σ_{d}^{L}), the bit rate controller 207 can adjust the spatial scale parameter (σ_{d}) to be equal to the lower threshold (σ_{d}=σ_{d}^{L}), and can communicate the adjusted spatial scale parameter (σ_{d}) to the filter 241 of the preprocessing circuitry 201. Method 400 can then continue at 421 and 423.

At 417, if the rate controller 207 determines that the adjusted spatial scale parameter (σ_{d}) is not within the range defined by the lower threshold (σ_{d}^{L}) and the higher threshold (σ_{d}^{H}) (e.g., the adjusted spatial scale parameter (σ_{d}) is greater than the higher threshold (σ_{d}^{H})), then at 427, the rate controller 207 adjusts the spatial scale parameter (σ_{d}) to be equal to the higher threshold (σ_{d}=σ_{d}^{H}) and adjusts a second parameter of the filter 241 of the preprocessing circuitry 201. In one example, the second parameter of the filter 241 is σᵣ (value scale parameter). For example, the rate controller 207 is configured to adjust the value scale parameter (σᵣ) by a preset value (e.g., by adding a value scale step size to the value scale parameter (σᵣ) or by subtracting a value scale step size from the value scale parameter (σᵣ).) According to some examples, if the adjusted quantization parameter determined at 411 is greater than the upper threshold of Q^{H}, then the rate controller 207 is configured to adjust the value scale parameter (σᵣ) by adding the value scale step size to the value scale parameter (σᵣ). In some examples, if the adjusted quantization parameter determined at 411 is less than the lower threshold of Q^{L}, then the rate controller 207 is configured to adjust the value scale parameter (σᵣ) by subtracting the value scale step size from the value scale parameter (σᵣ). In this examples the value scale step size can be stored in storage 231 where the rate controller 207 can access. It is noted that other methods can be used to adjust the value scale parameter (σᵣ). As one example, a set of value scale parameters (σᵣ) can be stored in, for example, storage 231 where the rate controller 207 can choose from when the value scale parameter (σᵣ) is to be adjusted.

After adjusting the value scale parameter (σᵣ), the rate controller 207 can compare the adjusted value scale parameter (σᵣ) with one or more thresholds at 429 and 431. In one example, the rate controller 207 can compare the adjusted value scale parameter (σᵣ) with a lower threshold (σᵣ^{L}) and/or a higher threshold (σᵣ^{H}). At 429 and 431, if the adjusted value scale parameter (σᵣ) is still within the range defined by the lower threshold (σᵣ^{L}) and the higher threshold (σᵣ^{H}) (σᵣ^{L}≤σᵣ≤σᵣ^{H}), the bit rate controller 207 can communicate the adjusted value scale parameter (σᵣ) to the spatial frequency control 241 (e.g., filter) of the preprocessing circuitry 201. Method 400 can continue at 421 and 423. In this example, at 421 the preprocessing circuitry 201 receives a next image (e.g., a next frame of a video) within the input data 211 from the imaging device 202. At 423, the preprocessing circuitry 201 adjusts the configuration parameter(s) of the spatial frequency control 241 (e.g., filter) and adjust the spatial frequency of the received next image using the updated configuration parameters (e.g., the adjusted spatial scale parameter (σ_{d}) and/or the adjusted value scale parameter (σᵣ).) Then method 400 returns to 401.

At 431, if the adjusted value scale parameter (σᵣ) is less than or equal to the higher threshold (σᵣ^{H}) and is also less that the lower threshold (σᵣ^{L}) (σᵣ<σᵣ^{L}), the bit rate controller 207 can adjust the value scale parameter (σᵣ) to be equal to the lower threshold (σᵣ=σᵣ^{L}), and can communicate the adjusted value scale parameter (σᵣ) to the filter 241 of the preprocessing circuitry 201. Method 400 can then continue at 421 and 423.

At 429, if the rate controller 207 determines that the adjusted value scale parameter (σᵣ) is not within the range defined by the lower threshold (σᵣ^{L}) and the higher threshold (σᵣ^{H}) (e.g., the adjusted value scale parameter (σᵣ) is greater than the higher threshold (σᵣ^{H}), then at 435, the rate controller 207 adjusts the value scale parameter (σᵣ) to be equal to the higher threshold (σᵣ=σᵣ^{H}).

At 440, the preprocessing circuitry 201 adjusts the configuration parameter(s) of the spatial frequency control 241 (e.g., filter) based on, for example, the adjusted spatial scale parameter (σ_{d}) and/or the adjusted value scale parameter (σᵣ). At 440, the preprocessing circuitry 201 can receive a next image from the imaging device 202 and can adjust the spatial frequency of the received next image using the updated configuration parameters of the spatial frequency control 241.

Method 400 further continues for adjusting configuration parameters of the color control 243 and/or the brightness control 245. In one example, at 441, the rate controller 207 adjusts the dimensionality of the color space of the received next image by a preset value to generate an adjusted image. According to some non-limiting examples, adjusting the dimensionality of the color space can include reducing the dimensionality of the color space by the preset value of 2^{K}^{_{c}}. In this example, K_{c} is a parameter associated with the color control 243 of the preprocessing 201. The parameter K_{c} can be an integer and can be initialized to have value of 1 at the beginning of the control process. In some examples, the initial value of the parameter K_{c} can be stored in storage 231. According to some embodiments reducing the dimensionality of the color space can include dividing the color value associated with each pixel of the image by 2^{K}^{_{c}}.

At 443, the encoder 203 encodes the adjusted image to generate the encoded image data. At 445, the transceiver 205 transmits the encoded image data. At 447, the rate controller 207 determines and/or receives a bit rate associated with the encoded data and at 449, the rate controller compares the bit rate to, for example, a determined bandwidth of the communication channel. If the determined bit rate is less than or equal to the bandwidth, then method 400 continues at 440.

However, if at 449 the rate controller 207 determines that the determined bit rate is greater than the bandwidth, the rate controller 207 adjusts one or more coding parameters of the encoder 203 (e.g., one or more quantization parameters) at 451. At 453, the rate controller 207 compares the adjusted one or more parameters with one or more thresholds. If the one or more coding parameters satisfy the one or more thresholds, the method 400 continues at 440. Steps 443-453 are similar to steps 401-413 discussed above.

If the one or more coding parameters do not satisfy the one or more thresholds, the method 400 continues at 455 where the rate controller 207 adjusts the preset value (e.g., parameter K_{c}) associated with the color control 243 of the preprocessing 201. According to some embodiments, the rate controller 207 adjusts the parameter K_{c} by adding a step size to parameter K_{c} or by subtracting a step size from parameter K_{c}. According to some examples, if the adjusted quantization parameter determined at 451 is greater than the upper threshold of Q^{H}, then the rate controller 207 is configured to adjust the parameter K_{c} by adding a step size to parameter K_{c}. In some examples, if the adjusted quantization parameter determined at 451 is less than the lower threshold of Q^{L}, then the rate controller 207 is configured to adjust the parameter K_{c} by subtracting a step size from parameter K_{c}. In some examples, the step size for adjusting the parameter K_{c} can be 1. It is noted that other methods and/or other values of the step size can be used for adjusting the parameter K_{c}. The step size for adjusting the parameter K_{c} can be stored in storage 231, according to some embodiments.

After adjusting the parameter K_{c}, the rate controller 207 determines whether the adjusted parameter K_{c} reached a threshold at 457. In some examples, the rate controller 207 compares the adjusted parameter K_{c} with an upper threshold (K_{c}^{H}). In some embodiments, the upper threshold (K_{c}^{H} ) can be 7, but other upper threshold values can also be used. The upper threshold (K_{c}^{H}) can be stored in storage 231. If the rate controller 207 at 457 determines that the adjusted parameter K_{c} has not reached the upper threshold, the rate controller 207 can communicate the adjusted parameter K_{c} to the color control 243 of the preprocessing circuitry 201 and the method 400 can continue at 440. In this example, the parameter K_{c} associated with the color control 243 of the preprocessing 201 is adjusted and the adjusted value of the parameter K_{c} is used at 441 for the next image of the input data 201. If at 457 the rate controller 207 determines that the adjusted parameter K_{c} has reached the upper threshold (K_{c}^{H}), the rate controller 207 adjusts parameter K_{c} to be equal to the upper threshold (K_{c}^{H}) and the method 400 continues at 460.

In some examples, the rate controller 207 compares the adjusted parameter K_{c} with a lower threshold (K_{c}^{L}). In some embodiments, the lower threshold (K_{c}^{L}) can be 0, but other lower threshold values can also be used. The lower threshold (K_{c}^{L}) can be stored in storage 231. If the rate controller 207 at 457 determines that the adjusted parameter K_{c} is greater than the lower threshold (K_{c}^{L}), the rate controller 207 can communicate the adjusted parameter K_{c} to the color control 243 of the preprocessing circuitry 201 and the method 400 can continue at 440. In this example, the parameter K_{c} associated with the color control 243 of the preprocessing 201 is adjusted and the adjusted value of the parameter K_{c} is used at 441 for the next image of the input data 201. If at 457 the rate controller 207 determines that the adjusted parameter K_{c} is less than the lower threshold (K_{c}^{L}), the rate controller 207 adjusts parameter K_{c} to be equal to the lower threshold (K_{c}^{L}), and the method 400 can continues at 427, according to some examples.

At 460, the preprocessing circuitry 201 adjusts the configuration parameter(s) of the spatial frequency control 241 (e.g., filter) based on, for example, the adjusted spatial scale parameter (σ_{d}) and/or the adjusted value scale parameter (σᵣ). At 460, the preprocessing circuitry 201 can receive a next image from the imaging device 202 and can adjust the spatial frequency of the received next image using the updated configuration parameters of the spatial frequency control 241. At 460, the preprocessing circuitry 201 can also adjust the dimensionality of the color space of this next image using the adjusted preset value from 455.

Method 400 further continues for adjusting configuration parameters of the brightness control 245. In one example, at 461, the rate controller 207 further adjusts the dimensionality of the brightness space of the received next image by a preset value to generate an adjusted image. According to some non-limiting examples, adjusting the dimensionality of the brightness space can include reducing the dimensionality of the color space by the preset value of 2^{K}^{_{b}}. In this example, K_{b} is a parameter associated with the brightness control 245 of the preprocessing 201. The parameter K_{b} can be an integer and can be initialized to have value of 1 at the beginning of the control process. In some examples, the initial value of the parameter K_{b} can be stored in storage 231. According to some embodiments reducing the dimensionality of the brightness space can include dividing the brightness value associated with each pixel of the image by 2^{K}^{_{b}}.

At 463, the encoder 203 encodes the adjusted image to generate the encoded image data. At 465, the transceiver 205 transmits the encoded image data. At 467, the rate controller 207 determines and/or receives a bit rate associated with the encoded data and at 469, the rate controller compares the bit rate to, for example, a determined bandwidth of the communication channel. If the determined bit rate is less than or equal to the bandwidth, then method 400 continues at 460.

However, if at 469 the rate controller 207 determines that the determined bit rate is greater than the bandwidth, the rate controller 207 adjusts one or more coding parameters of the encoder 203 (e.g., one or more quantization parameters) at 471. At 473, the rate controller 207 compares the adjusted one or more parameters with one or more thresholds. If the one or more coding parameters satisfy the one or more thresholds, the method 400 continues at 460. Steps 463-473 are similar to steps 401-413 discussed above.

If the one or more coding parameters do not satisfy the one or more thresholds, the method 400 continues at 475 where the rate controller 207 adjusts the preset value (e.g., parameter K_{b}) associated with the brightness control 245 of the preprocessing 201. According to some embodiments, the rate controller 207 adjusts the parameter K_{b} by adding a step size to parameter K_{b} or by subtracting a step size from parameter K_{b}. According to some examples, if the adjusted quantization parameter determined at 471 is greater than the upper threshold of Q^{H}, then the rate controller 207 is configured to adjust the parameter K_{b} by adding a step size to parameter K_{b}. In some examples, if the adjusted quantization parameter determined at 471 is less than the lower threshold of Q^{L}, then the rate controller 207 is configured to adjust the parameter K_{b} by subtracting a step size from parameter K_{c}. In some examples, the step size for adjusting the parameter K_{b} can be 1. It is noted that other methods and/or other values of the step size can be used for adjusting the parameter K_{b}. The step size for adjusting the parameter K_{b} can be stored in storage 231, according to some embodiments.

After adjusting the parameter K_{b}, the rate controller 207 determines whether the adjusted parameter K_{b} reached a threshold at 477. In some examples, the rate controller 207 compares the adjusted parameter K_{b} with an upper threshold (K_{b}^{H}). In some embodiments, the upper threshold (K_{b}^{H}) can be 7, but other threshold values can also be used. The upper threshold (K_{c}^{H}) can be stored in storage 231. If the rate controller 207 at 477 determines that the adjusted parameter K_{b} has not reached the upper threshold, the rate controller 207 can communicate the adjusted parameter K_{b} to the brightness control 245 of the preprocessing circuitry 201 and the method 400 can continue at 460. In this example, the parameter K_{b} associated with the brightness control 245 of the preprocessing 201 is adjusted and the adjusted value of the parameter K_{b} is used at 461 for the next image of the input data 201.

If at 477 the rate controller 207 determines that the adjusted parameter K_{b} has reached the upper threshold (K_{b}^{H}), the rate controller 207 adjusts parameter K_{b} to be equal to the upper threshold (K_{b}^{H}) and method 400 can continue at 479 by issuing an error message, according to some embodiments. The error message can indicate that the state parameters of system 200 (e.g., bit rate associated with the encoded image data, the coding parameter(s) (e.g., the quantization parameter), PSNR, and/or storage space of one or more buffers, etc.) are not within a preset range and the parameter(s) of the preprocessing circuitry 201 are also outside of the predetermined range. Additionally or alternative, the method 400 can continue to 460 where the next frames within the input data 211 can be preprocessed using the preprocessing circuitry 201 using the parameter(s) of the preprocessing circuitry 201, which is now at its maximum threshold.

In some examples, the rate controller 207 compares the adjusted parameter K_{b} with a lower threshold (K_{b}^{L}). In some embodiments, the lower threshold (K_{b}^{L}) can be 0, but other lower threshold values can also be used. The lower threshold (K_{b}^{L}) can be stored in storage 231. If the rate controller 207 at 477 determines that the adjusted parameter K_{b} is greater than the lower threshold (K_{b}^{L}), the rate controller 207 can communicate the adjusted parameter K_{b} to the brightness control 245 of the preprocessing circuitry 201 and the method 400 can continue at 460. In this example, the parameter K_{b} associated with the brightness control 245 of the preprocessing 201 is adjusted and the adjusted value of the parameter K_{c} is used at 461 for the next image of the input data 201. If at 477 the rate controller 207 determines that the adjusted parameter K_{b} is less than the lower threshold (K_{b}^{L}), the rate controller 207 adjusts parameter K_{b} to be equal to the lower threshold (K_{b}^{L}), and the method 400 can continues at 427, according to some examples.

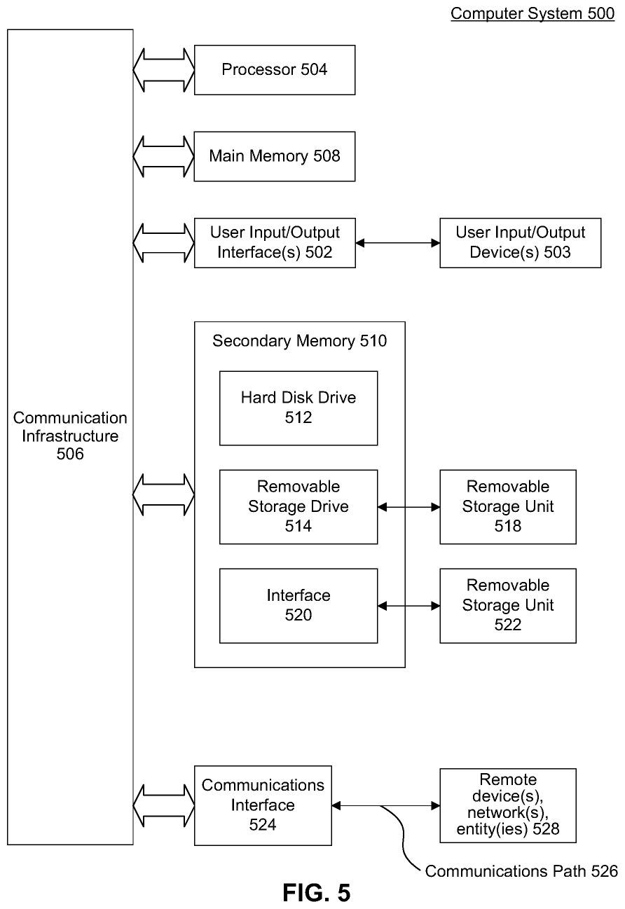

Various embodiments can be implemented, for example, using one or more well-known computer systems, such as computer system 500 shown in FIG. 5. For instance, each of the components and/or operations described with reference to FIGS. 1, 2A, 2B, 3A-3C, and 4A-4D could be implemented using one or more computer systems 500 or portions thereof. Computer system 500 can be used, for example, to implement method 300 of FIGS. 3A-3D or method 400 of FIGS. 4A-4D. For example, computer system 500 can be used for preprocessing and parameter control, according to some embodiments. The computer system 500 can be any computer capable of performing the functions described herein.

The computer system 500 includes one or more processors (also called central processing units, or CPUs), such as a processor 504. The processor 506 is connected to a communication infrastructure or bus 506.

The processor 506 may be, for example, a graphics processing unit (GPU). In some embodiments, the GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 500 also includes user input/output/display device(s) 522, such as monitors, keyboards, pointing devices, etc., that communicate with communication infrastructure 504.

The computer system 500 also includes a main or primary memory 508, such as random access memory (RAM). The main memory 508 may include one or more levels of cache. The main memory 508 has stored therein control logic 528A (e.g., computer software) and/or data.

The computer system 500 may also include one or more secondary storage devices or memory 510. The secondary memory 510 may include, for example, a hard disk drive 512 and/or a removable storage device or drive 514. The removable storage drive 514 may be a floppy disk drive, a magnetic tape drive, a compact disk drive, an optical storage device, tape backup device, and/or any other storage device/drive.

The removable storage drive 514 may interact with a removable storage unit 516. The removable storage unit 518 includes a computer usable or readable storage device having stored therein control logic 528B (e.g., computer software) and/or data. The removable storage unit 518 may be a floppy disk, magnetic tape, compact disk, DVD, optical storage disk, and/any other computer data storage device. The removable storage drive 514 reads from and/or writes to the removable storage unit 516.

The computer system 500 may further include a communication or network interface 518. The communication interface 518 enables the computer system 500 to communicate and interact with any combination of remote devices, remote networks, remote entities, etc. (individually and collectively referenced by reference number 530). For example, communication interface 518 may allow the computer system 500 to communicate with remote devices 530 over a communications path 526, which may be wired and/or wireless, and which may include any combination of LANs, WANs, the Internet, etc. Control logic and/or data may be transmitted to and from computer system 500 via communication path 526.

In some embodiments, a tangible apparatus or article of manufacture including a tangible computer useable or readable medium having control logic (software) stored thereon is also referred to herein as a “computer program product” or “program storage device.” This includes, but is not limited to, the computer system 500, the main memory 508, the secondary memory 510, and the removable storage unit 516, as well as tangible articles of manufacture embodying any combination of the foregoing. Such control logic, when executed by one or more data processing devices (such as the computer system 500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure so that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the present disclosure should not be limited by any of the above-described exemplary embodiments, but should be defined only in accordance with the following claims and their equivalents.

The claims in the instant application are different than those of any parent application or other related applications. The Applicant therefore rescinds any disclaimer of claim scope made in the parent application or any predecessor or related application in relation to the instant application. The Examiner is therefore advised that any such previous disclaimer and the cited references that it was made to avoid, may need to be revisited. Further, the Examiner is also reminded that any disclaimer made in the instant application should not be read into or against the parent or related application(s).

1. An image processing method, comprising:
receiving, by a processor, one or more images from an imaging device carried on a movable object;
adjusting one or more imaging parameters of at least one of the one or more images to obtain an adjusted image;
encoding the adjusted image to generate encoded image data; and
transmitting the encoded image data from the movable object to a remote terminal.

2. The method of claim 1, wherein the adjusting one or more imaging parameters comprises:
reducing the one or more imaging parameters of the at least one of the one or more images.

3. The method of claim 1, wherein the one or more imaging parameters comprises at least one of a spatial frequency, a dimensionality of a color space, or a dimensionality of a brightness space of the at least one of the one or more images.

4. The method of claim 1, wherein the adjusting one or more imaging parameters comprises:
adjusting the one or more imaging parameters in response to one or more state parameters associated with the movable object not being within a preset range.

5. The method of claim 4, wherein the adjusting one or more imaging parameters comprises:
adjusting the one or more imaging parameters in response to a quantization parameter for encoding being equal to or greater than a first quantization parameter threshold.

6. The method of claim 5, wherein the quantization parameter is adjusted according to a bandwidth of a communication channel between the movable object and the remote terminal.

7. The method of claim 4, wherein the adjusting one or more imaging parameters comprises:
adjusting the one or more imaging parameters in response to a peak signal-to-noise ratio (PSNR) value of one or more prior images received from the imaging device being equal to or less than a PSNR threshold.

8. The method of claim 4, wherein the adjusting one or more imaging parameters comprises:
adjusting the one or more parameters in response to an occupied storage space in a buffer being equal to or greater than a threshold, wherein the buffer is used to cache encoded image data of one or more prior images received from the imaging device.

9. The method of claim 1, wherein the adjusting one or more imaging parameters comprises:
adjusting a spatial frequency of the at least one of the one or more images.

10. The method of claim 9, wherein the adjusting a spatial frequency comprises:
adjusting the spatial frequency of the at least one of the one or more images using a filter.

11. The method of claim 10, wherein the filter comprises a bilateral filter.

12. The method of claim 11, further comprising:
before adjusting the spatial frequency, adjusting one or more configuration parameters of the bilateral filter, wherein the one or more configuration parameters of the bilateral filter comprise at least one of a spatial scale parameter or a value scale parameter.

13. The method of claim 12, wherein the adjusting one or more configuration parameters of the bilateral filter comprises:
adjusting the spatial scale parameter and the value scale parameter based on a preset order.

14. The method of claim 1, wherein the adjusting one or more imaging parameters comprises:
adjusting a dimensionality of a color space of the at least one of the one or more images.

15. The method of claim 14, wherein the adjusting a dimensionality of a color space comprises:
adjusting the dimensionality of the color space of the at least one of the one or more images by a preset value.

16. The method of claim 1, wherein the adjusting one or more imaging parameters comprises:
adjusting a dimensionality of a brightness space of the at least one of the one or more images.

17. The method of claim 16, wherein the adjusting a dimensionality of a brightness space comprises:
adjusting the dimensionality of the brightness space of the at least one of the one or more images by a preset value.

18. The method of claim 1, wherein the one or more imaging parameters include at least two imaging parameters, and the adjusting one or more imaging parameters comprises:
adjusting the at least two imaging parameters of the at least one of the one or more images.

19. The method of claim 18, wherein the adjusting the at least two imaging parameters comprises:
adjusting the at least two imaging parameters based on a preset priority.

20.-64. (canceled)

65. An imaging system, comprising:
an imaging device carried on a movable object and configured to capture one or more images; and
one or more processors, upon executing instructions, individually or collectively, configured to:
adjust one or more imaging parameters of at least one of the one or more images to obtain an adjusted image;
encode the adjusted image to generate encoded image data; and
transmit, using a transceiver, the encoded image data from the movable object to a remote terminal.

66.-192. (canceled)
